(19) United States
(12) Patent Application Publication
(10) Pub. No.: US 2025/0377135 A1
(43) Pub. Date: Dec. 11, 2025

(54) PTC HEATER DEVICE

(71) Applicants: HYUNDAI MOTOR COMPANY, Seoul (KR); KIA CORPORATION, Seoul (KR)

(72) Inventors: Young Su Nam, Hwaseong-si (KR); Jae Won Heo, Hwaseong-si (KR); Seung Hoon Moon, Hwaseong-si (KR); Sang Yeop Lee, Hwaseong-si (KR); Jung Mo Kwak, Hwaseong-si (KR); Myung Jun Kim, Hwaseong-si (KR); Jin Han Kim, Hwaseong-si (KR); Young Taek Hong, Hwaseong-si (KR); Gyeong Won Jeong, Hwaseong-si (KR); Kyeong Min Kang, Hwaseong-si (KR); Sang Shin Lee, Hwaseong-si (KR); Hae Ryong Park, Hwaseong-si (KR)

(73) Assignees: HYUNDAI MOTOR COMPANY, Seoul (KR); KIA CORPORATION, Seoul (KR)

(21) Appl. No.: 18/955,309

(22) Filed: Nov. 21, 2024

(30) Foreign Application Priority Data
Jun. 11, 2024 (KR) 10-2024-0075671

(51) Int. Cl. F24H 3/04; B60H 1/22; H05B 3/06

(52) U.S. Cl. CPC F24H 3/0441; B60H 1/2225; H05B 3/06; B60H 2001/2296; H05B 2203/007; H05B 2203/016; H05B 2203/02

(57) ABSTRACT

A PTC heater device includes a housing unit, a PTC unit fastened to the housing unit including a plurality of PTC rods and a heat exchanger portion, and a ground terminal to which some parts of the plurality of PTC rods are fastened. At least one of the plurality of PTC rods has a structure that is separated.

### CROSS REFERENCE TO RELATED APPLICATION

The present application claims priority to Korean Patent Application No. 10-2024-0075671, filed Jun. 11, 2024, the entire contents of which are incorporated herein for all purposes by this reference.

### BACKGROUND

### Technical Field

The present disclosure relates to a Positive Temperature Coefficient (PTC) heater device and, more specifically, to a PTC heater device that generates an increased output in a small space by improving the configuration of the PTC heater device mounted on a vehicle and the coupling structure of a plurality of PTC rods.

### Description of the Related Art

A Positive Temperature Coefficient (PTC) stone is an electrical element widely used as a heating element in an auxiliary heater for vehicles. Generally, the electrical resistance of a material does not change significantly as a temperature of the material changes. However, in the case of PTC stones, electrical resistance increases sharply as the temperature rises and reaches a certain point. Accordingly, when the temperature rises above a certain level, the resistance increases, and the amount of current that may flow through the PTC stone decreases due to the increased resistance. Accordingly, an amount of heat generation decreases with the decreased amount of current, causing the temperature to decrease again. When the temperature decreases, the resistance decreases. When the resistance decreases, the relative amount of current that may flow through the PTC stone increases, and the amount of heat generated increases. Accordingly, the temperature increases, and then the resistance of the PTC stone increases again. This may be referred as a circulation mechanism.

Therefore, when a PTC heater device is used, a constant temperature may be maintained. When used as an auxiliary heater for a vehicle, in order to briefly heat the interior during a period of time when the vehicle's heater does not generate heat due to the coolant not being heated, such as, during winter or just after starting the engine, the PTC heater device may complement the vehicle's heating performance by increasing the temperature of the air introduced toward the PTC heater device side.

Such a PTC heater device is generally made by arranging and combining a plurality of PTC rods in which a plurality of PTC stones are arranged. Moreover, the output of the PTC heater device is proportional to the number of PTC stones arranged. Furthermore, in the case of a large vehicle with a wide vehicle width, the PTC heater device has a widened width so that a plurality of PTC stones may be arranged. In other words, the greater the number of PTC stones, the greater the output the PTC heater device.

On the other hand, recently, as the demand for cars with narrow widths has increased, research is being actively conducted on the structure of the PTC heater device that may generate higher output in cars with narrow widths and the coupling relationship between multiple PTC rods.

The foregoing is intended merely to enhance understanding of the background of the present disclosure. Thus, the foregoing is not intended to mean that the present disclosure falls within the purview of the related art that is already known to those of ordinary skill in the art.

### SUMMARY

Accordingly, the present disclosure has been made keeping in mind the above problems occurring in the related art. The present disclosure is intended to provide a PTC heater device that may generate a maximum or increased heat output in a vehicle capable of performing only two-stage control. In addition, the present disclosure includes a plurality of PTC rods, has a structure in which one of the plurality of PTC rods is separated, and is intended to generate high output in a vehicle capable of only two-stage control.

The objectives of the present disclosure are not limited to the objectives mentioned above. Other objectives of the present disclosure that are not mentioned should be understood by the following description and should be more clearly understood by the embodiments of the present disclosure. In addition, the objectives of the present disclosure may be realized by means indicated in the claims and combinations thereof.

The PTC heater device for achieving the objectives of the present disclosure described above may have the following configuration.

The PTC heater device of the present disclosure may include: a housing unit; a PTC unit fastened to the housing unit and including a plurality of PTC rods and a heat exchanger portion; and a ground terminal to which some parts of the plurality of PTC rods are fastened. At least one of the plurality of PTC rods has a structure that is separated.

In addition, the plurality of PTC rods may be composed of a first rod, a second rod, and a third rod. Any one of the first rod, the second rod, and the third rod may have the structure that is separated.

In addition, among the plurality of PTC rods, the PTC rod configured to have the structure that is separated may include a first sub-rod and a second sub-rod.

In addition, the PTC heater device may further include: a first PTC module in which the first sub-rod and one of the plurality of PTC rods that are not separated are connected in series.

In addition, the PTC heater device may further include a second PTC module in which the second sub-rod and a PTC rod of the plurality of PTR rods that is not connected to the first sub-rod are connected in series.

In addition, the first PTC module and the second PTC module may be connected to each other in parallel.

In addition, the first module and the second module may be configured to have a parallel structure when part of the first PTC module and part of the second PTC module are fastened to the ground terminal and energized by being connected to the same external power source.

In addition, the first PTC module may have a structure in which the first sub-rod is connected to a PTC rod of the plurality of PTC rods, which is not separated, with a first busbar, and the second PTC module may have a structure in which the second sub-rod is connected to the PTC rod of the plurality of PTC rods, which is not connected to the first sub-rod, with a second busbar.

In addition, the housing unit may include: a lower housing; and an upper housing fastened to the ground terminal.

In addition, each of the plurality of PTC rods may include: a guide having a plurality of grooves; an electrode plate configured to be fastened to the guide; a terminal connected to one end of the electrode plate; a PTC stone fastened to each of upper grooves of the guide; and an insulating portion fastened to each of lower grooves of the guide.

In addition, one of the plurality of PTC rods not having a structure that is separated, has the electrode plate having opposite ends each connected to the terminal.

In addition, the ground terminal may include: two electrical terminals; and a plurality of terminal grooves into which some parts of the plurality of PTC rods are inserted.

In addition, the plurality of terminal grooves may include two adjacent terminal grooves located between the two electrical terminals, each having one open end.

In addition, a PTC unit including: a plurality of PTC rods; a heat exchanger portion configured to be fastened to the plurality of PTC rods; and a ground terminal to which some parts of the plurality of PTC rods are fastened, wherein a terminal is connected to each of opposite ends of one of the plurality of PTC rods, and a PTC rod of the plurality of PTC rods that does not have the terminal connected to each of the opposite ends has the terminal connected to one end thereof.

In addition, any one of the plurality of PTC rods may have a structure that is separated.

In addition, a PTC rod of the plurality of PTC rods, that does not have a separated structure, may have an electrode plate having opposite ends each connected to the terminal.

In addition, the PTC rod having opposite ends each having the terminal connected thereto may include a first sub-terminal and a second sub-terminal.

In addition, one of the first sub-terminal and the second sub-terminal may be connected to the terminal of the PTC rod having the structure that is separated.

In addition, another of the first sub-terminal and the second sub-terminal that is not connected to the terminal of the PTC rod having the structure that is separated may be configured to be fastened to the ground terminal.

The present disclosure may achieve the following effects by combining the above-mentioned embodiments with the configurations, combinations, and use relationships described below.

First, the number of relays and consumption of fuses may be reduced through two-stage control, thereby achieving economic effects.

Second, the effect, in which maximum or increased power that may be generated in 3-stage control can be achieved through 2-stage control, can be obtained.

### BRIEF DESCRIPTION OF THE DRAWINGS

The above and other objectives, features, and advantages of the present disclosure should be more clearly understood from the following detailed description when taken in conjunction with the accompanying drawings, in which:

FIG. 1 is an exploded view showing a Positive Temperature Coefficient (PTC) heater device according to an embodiment of the present disclosure;

FIG. 2 a view showing a structure in which a PTC rod located in the middle of a plurality of PTC rods is separated as according to an embodiment of the present disclosure;

FIG. 3A is a perspective view showing a ground terminal as according to an embodiment of the present disclosure;

FIG. 3B is a front view showing the ground terminal as according to an embodiment of the present disclosure;

FIG. 4 is a view showing a circuit connection state of the PTC rods and ground terminals as according to an embodiment of the present disclosure;

FIG. 5A is a view showing a structure in which an upper-end PTC rod among the plurality of PTC rods is separated as according to another embodiment of the present disclosure;

FIG. 5B is a view showing a structure in which a lower-end PTC rod among the plurality of PTC rods is separated as according to another embodiment of the present disclosure; and

FIG. 6 is a view showing a circuit diagram of two-stage control as according to an embodiment of the present disclosure.

### DETAILED DESCRIPTION

Hereinafter, embodiments of the present disclosure are described in more detail with reference to accompanying drawings. Embodiments of the present disclosure may be modified in various forms, and the scope of the present disclosure should not be construed as being limited to the following embodiments. The embodiments or examples are provided to more completely explain the present disclosure to those who have ordinary skill in the art.

In addition, terms such as “ . . . part”, “ . . . unit”, and the like used in the specification refer to a unit that processes at least two functions or operations, such as a processor, which may be implemented by hardware, software, or a combination of hardware and software. As described below, a processor may be paired with memory, for example, storing one or more sets of rules or algorithms implemented by the processor.

In addition, the terms used in the specification are merely used to describe specific embodiments and are not intended to limit the embodiments. Singular expressions include plural expressions unless the context clearly dictates otherwise. When a component, device, element, or the like of the present disclosure is described as having a purpose, or performing an operation, function, or the like, the component, device, or element should be considered herein as being “configured to” meet that purpose or perform that operation or function.

In addition, throughout the specification, when it is said that a part “includes” a certain component, the presence of additional or other components is not excluded, and the part may further include additional or other components, unless specifically stated to the contrary. In addition, terms such as “controller” and the like used in the specification refer to a unit that processes at least two functions or operations.

In addition, the controller may be implemented with memory and a processor. The memory stores data for an algorithm for controlling the operation of various components disposed in the vehicle or for a program that reproduces the algorithm. The processor performs the above-described operations using the data stored in the memory. At this time, the memory and processor may be respectively implemented as separate chips. Alternatively, the memory and processor may be implemented as a single chip. For example, the controller may be configured by including at least two of an Electronic Control Unit (ECU), Central Processing Unit (CPU), Micro Processor Unit (MPU), Micro Controller Unit (MCU), Application Processor (AP), or any type of processor that is well-known in the art.

In addition, the controller may be configured with a combination of software and hardware capable of performing operations on at least two applications or programs for executing methods according to the embodiments of the present disclosure.

Hereinafter, an embodiment of the present disclosure is described in detail with reference to the accompanying drawings. In the description with reference to the accompanying drawings, identical or corresponding components have been assigned the same drawing numbers or reference characters and duplicative descriptions thereof have been omitted.

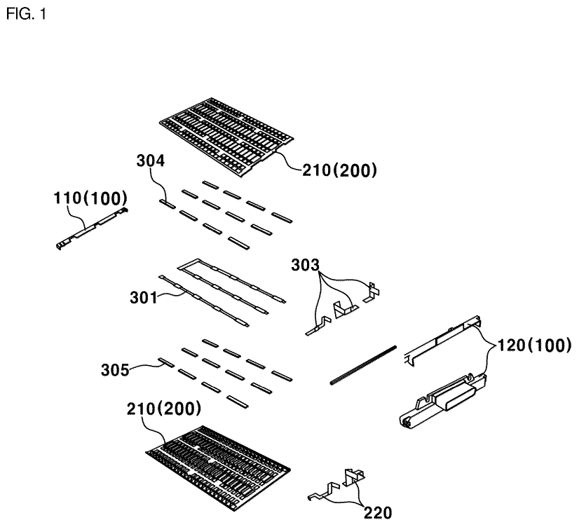

FIG. 1 is an exploded view showing a Positive Temperature Coefficient (PTC) heater device.

According to an embodiment of the present disclosure, the PTC heater device includes a PTC unit 200 that varies resistance (e.g., that has a varying resistance) according to temperature to generate heat, a housing unit 100 to which the PTC unit 200 is fastened, a ground terminal 220 fastened to part of the housing unit 100, and a protection bar configured to wrap a side surface of the PTC unit 200.

More specifically, the PTC unit 200 may include a PTC rod that varies resistance (e.g., that has a varying resistance) according to temperature to generate heat and a heat exchanger portion 210 that is fastened to the PTC rod and contacts air to perform heat exchange.

Furthermore, the present disclosure may include a plurality of PTC rods 300. Any one of the plurality of PTC rods 300 may be configured to have a structure that is separated. More specifically, the plurality of PTC rods 300 may include three PTC rods, and any one of the three PTC rods may be configured to have a structure that is separated. Moreover, the PTC rod including the structure that is separated may be composed of two sub-rods. More specifically, the two sub-rods may include a first sub-rod 340 and a second sub-rod 350. Moreover, the first sub-rod 340 may be connected in series with a PTC rod (e.g., a first PTC rod) that is not separated, and the second sub-rod 350 may be connected in series with a PTC rod (e.g., a second PTC rod) that is not connected to the first sub-rod 340 of the PTC rods that are not separated.

Moreover, the first PTC module 360 as shown in FIG. 4 may be composed of the first sub-rod 340 and the PTC rod connected in series to the first sub-rod 340, and the second PTC module 370 as shown in FIG. 4 may be composed of the second sub-rod 350 and the PTC rod connected in series to the second sub-rod 350. Moreover, the first PTC module 360 and the second PTC module 370 may be coupled with an external power source and connected in a parallel structure.

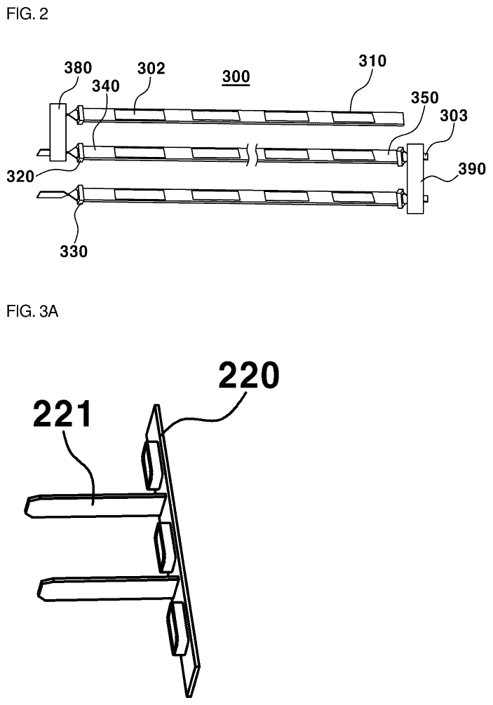

In addition, referring to FIGS. 1 and 2, the PTC rod includes a guide 301 including a plurality of grooves, an electrode plate 302 inserted into the inner side of the guide 301, a terminal 303 connected to the electrode plate 302, PTC stones 304 respectively fastened to upper surface grooves of the guide 301, and insulating portions respectively fastened to lower surface grooves of the guide 301. In addition, the guide 301 may be manufactured with synthetic resin to maintain an insulating state.

In addition, the guide 301 may include an insertion portion into which the electrode plate 302 may be inserted. Furthermore, a terminal 303 configured to be connected to an external power source may be fastened to one end or each of opposite ends of the electrode plate 302 inserted into the guide 301. Moreover, the terminal 303 may refer to a positive terminal to which positive (+) power source is applied. In addition, the terminal 303 fastened to the guide 301 may be fastened to a ground terminal 220 including two electrical terminals 221 and three terminal grooves 222.

In addition, the guide 301 may include a plurality of grooves. Here, a PTC stone 304 may be inserted into each of a plurality of upper grooves, and an insulating portion 305 may be inserted into each of a plurality of lower grooves.

Moreover, the electrode plate 302 is inserted into the insertion portion of the guide 301, and the PTC stone 304 is inserted into each of the plurality of upper grooves of the guide 301 so that the PTC stone 304 may be in contact with the upper surface of the electrode plate 302. Furthermore, an insulating portion 305 may be inserted into each of the plurality of lower grooves of the guide 301, so that the insulating portion 305 may be in contact with the lower surface of the electrode plate 302.

In addition, a heat bar may be configured to encircle the guide 301. Furthermore, the heat bar may include an upper-end heat bar in contact with the PTC stone 304 and a lower-end heat bar in contact with the insulating portion 305. Moreover, the heat bar is composed of a conductor, and the upper-end heat bar in contact with the PTC stone 304 may be electrically energized.

Furthermore, the heat bar may be energized by contacting the ground terminal 220, so the current applied through the terminal 303 may flow to an external power source through the heat bar and the ground terminal 220.

In addition, the heat bar may perform the role of serving to transfer heat generated from the PTC stone 304 to the heat exchanger portion 210. Moreover, heat exchange is performed with external or internal air in the heat exchanger portion 210 connected to the heat bar. Accordingly, the temperature of the discharged air passing through the heat exchanger portion 210 may be increased. In addition, the heat exchanger portion 210 may be manufactured in a grid shape such as a flat plate fin, louver fin, or honeycomb structure to effectively establish heat exchange between the heat generated by the PTC stone 304 and air. The heat exchanger portion 210 may be provided in various structures and shapes.

In addition, current from an external power source is applied to the terminal 303, and the applied current is passed to the electrode plate 302. At this time, heat may be generated due to the resistance of the PTC stone 304 in contact with the upper surface of the electrode plate 302. In other words, the PTC stone 304 may vary its resistance depending on the temperature, thereby controlling the amount of heat generated from the PTC rod, and this is related to the heat output.

As an example, when the temperature decreases, the resistance of the PTC stone 304 decreases. When the resistance of the electrode plate 302 decreases, the amount of current passing through the electrode plate 302 increases, and the amount of heat generated increases. On the contrary, when the temperature rises, the resistance of the PTC stone 304 increases. When the resistance of the electrode plate 302 increases, the amount of current passing through the electrode plate 302 decreases and the amount of heat generated decreases.

In addition, the housing unit 100 may include a structure to which the PTC unit 200 is fastened. Moreover, the housing unit 100 may include a lower housing 110 to which one end of the PTC unit 200 is fastened and an upper housing 120 to which the ground terminal 220 is fastened. Moreover, the PTC unit 200 may be fastened to the inner side of the ground terminal 220. The ground terminal 220 and the PTC unit 200 in a connected state may be fastened to the upper housing 120. Furthermore, a plurality of PTC rods 300 of the PTC unit 200 may be inserted into a groove included at the inner side of the lower housing 110.

Furthermore, one end of the protection bar may be fastened to the lower housing 110, an opposite end of the protection bar may be fastened to the upper housing 120, and the heat exchanger portion 210 may be fastened to the inner side of the protection bar. Moreover, one of the one end and the opposite end of the protection bar may be fastened to the lower housing 110 or the upper housing 120, through an insertion fitting method.

Moreover, the ground terminal 220 to which the terminal 303 of the PTC rod is fastened includes an electrical terminal 221 connected to an external power source. The ground terminal 220 may include a plurality of terminal grooves 222 into which the terminal 303 may be inserted. Moreover, the electrical terminal 221 included in the ground terminal 220 may refer to a negative terminal to which a negative (−) pole is connected.

Accordingly, the positive (+) pole may be connected to the terminal 303 and the negative (−) pole may be connected to the electrical terminal 221 of the ground terminal 220 to provide a circuit through which current flows. Furthermore, the ground terminal 220 may include terminal grooves 222 into which the terminal 303 of the PTC module is inserted. More precisely, the ground terminal may include three terminal grooves 222.

FIG. 2 is a view showing a structure in which a PTC rod located in the middle of a plurality of PTC rods is separated.

According to an embodiment of the present disclosure, the plurality of PTC rods 300 includes one PTC rod 300 having a structure that is separated. More specifically, the plurality of PTC rods 300 may include a first rod 310 located at the top, a third rod 330 located at the bottom, and a second rod 320 located between the first rod 310 and the third rod 330, as shown in FIG. 2.

Moreover, as shown in FIG. 2, the second rod 320 may have a structure that is separated at the center along the longitudinal direction. Here, the second rod 320 is a PTC rod that is separated and may have a first sub-rod 340 located at one end in the longitudinal direction and a second sub-rod 350 located adjacent to the first sub-rod 340 along the longitudinal direction 350.

In addition, as another embodiment of the present disclosure, each of a third sub-rod, fourth sub-rod, fifth sub-rod, and sixth sub-rod disclosed may also refer to a portion of a separate sub-rod of a corresponding PTC rod.

In addition, the first sub-rod 340 may be connected in series with one of the PTC rods that is not separated among the plurality of PTC rods 300. More specifically, the first sub-rod 340 may be connected in series with the first rod 310 through a busbar to be electrically energized. The first PTC module 360 may refer to a structure in which the first sub-rod 340 and the first rod 310 are electrically connected in series.

In addition, the busbar connecting the first sub-rod 340 and the first rod 310 may refer to a first busbar 380. More specifically, the terminal 303 of the first sub-rod 340 and the terminal 303 of the first rod 310, which are connected through the first busbar 380, may be configured to provide a first terminal complex.

Furthermore, the first PTC module 360 may be inserted into the ground terminal 220 and connected to the electrical terminal 221 of the ground terminal 220 in series to be electrically energized. More specifically, the first PTC module 360 is applied with the positive (+) pole through the first terminal complex, and the applied current passes through the electrode plate 302 and the PTC stone 304 and flows to the heat bar, the heat bar may contact the negative (−) electrical terminal 221 of the ground terminal 220 and have a negative (−) current flowing therethrough.

Likewise, the second sub-rod 350 may be connected in series with the third rod 330 through a second busbar 390 to be electrically energized. The second PTC module 370 may refer to a structure in which the second sub-rod 350 and the third rod 330 are electrically connected in series.

Moreover, the first PTC module 360 and the second PTC module 370 may be configured in a parallel structure. More specifically, the wire connected to the terminal 303 of the first PTC module 360 and the wire connected to the terminal 303 of the second PTC module 370 may be connected to the same positive (+) external power source. Furthermore, the wires connected to the two electrical terminals 221 of the ground terminal 220 may be connected to the same negative (−) power source of the external power source. Therefore, due to this structure, the first PTC module 360 and the second PTC module 370 may be configured in an overall parallel structure.

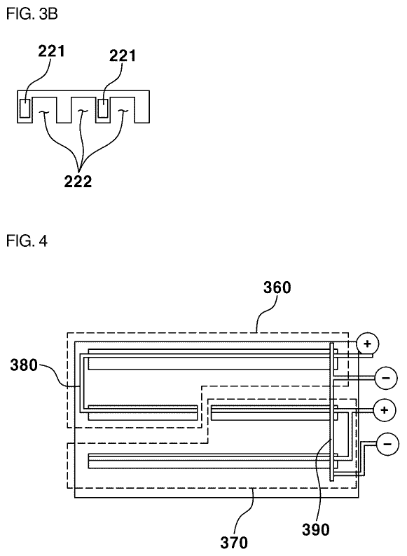

FIG. 3A is a perspective view showing a ground terminal, and FIG. 3B is a front view showing the ground terminal.

Conventionally, when three terminals 303, respectively connected to the three PTC rods, are inserted into the ground terminal 220, five electrical terminals connected to an external power source are located in the ground terminal 220, three of the five electrical terminals are connected to the positive (+) pole of the external power source, and the remaining two terminals are connected to the negative (−) pole of the external power source. In other words, three positive (+) pole terminals and two negative (−) pole terminals are located in the ground terminal 220.

as According to another embodiment of the present disclosure, the first PTC module 360 and the second PTC module 370 may be inserted into the ground terminal 220. Moreover, when the terminal 303 of the first PTC module 360 and the terminal 303 of the second PTC module 370 are inserted into the ground terminal 220, four electrical terminals may be located in the ground terminal 220. More specifically, two positive (+) poles and two negative (−) poles may be located. Furthermore, when the circuit is composed of the two positive (+) poles and the two negative (−) poles, an overcurrent flowing in any one direction in the circuit may be prevented.

In addition, FIG. 3B shows a disposition of a plurality of terminal grooves 222 and two electrical terminals 221, and conventionally, each of the two electrical terminals 221 may be disposed between two of the three terminal grooves 222. More specifically, one electrical terminal 221 may be disposed between two terminal grooves 222.

In the present disclosure, as shown in FIG. 3B, two adjacent terminal grooves 222 may be disposed between two negative (−) electric terminals 221. More specifically, the first terminal complex is inserted into the two adjacent terminal grooves 222. Two adjacent terminal grooves 222 may be configured to be a structure in which one end of each of the two adjacent terminal grooves is open so that the first terminal complex may be easily inserted. More specifically, one of the terminal grooves 222 that is not located between the two negative (−) electric terminals 221 may be configured to be a structure in which an end thereof is open.

Furthermore, when the ground terminal 220 and the PTC modules are fastened to each other, the PTC modules may be inserted along the open bottom of the ground terminal 220.

FIG. 4 is a view showing the electrode connection state of the PTC module and the ground terminal 220.

According to an embodiment of the present disclosure, the first PTC module 360 is configured in a series connection structure, and the second PTC module 370 is also configured in a series connection structure.

For example, the first PTC module 360 is applied with the positive (+) pole of an external power source through the first terminal complex, and the applied current is applied to a PTC element through the electrode plate 302 inserted inside the guide 301. In addition, the current applied to the PTC element is configured to energize the upper-end heat bar in contact with the PTC element. In this way, the current applied to the heat bar may flow to the negative (−) pole of the external power source through the negative (−) electrical terminal 221 of the ground terminal 220. In the second PTC module 370, the current flow is the same as that in the first PTC module 360.

Moreover, a positive (+) pole of the one external power supply may be electrically connected to the terminals 303 of the first PTC module 360 and the second PTC module 370. In addition, the negative (−) pole of one external power source may be electrically connected to each of the two electric terminals 221 of the ground terminal 220.

Accordingly, the first PTC module 360 and the second PTC module 370 may be connected in a parallel structure. In addition, the first PTC module 360 and the second PTC module 370 are connected in a parallel structure, so each module may be electrically energized independently of the other.

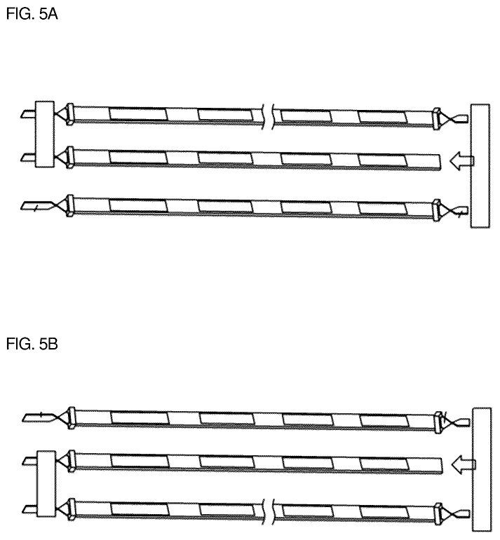

FIGS. 5A and 5B show other embodiments of the present disclosure. FIG. 5A is a view showing a structure in which an upper-end PTC rod among the plurality of PTC rods is separated.

According to another embodiment of the present disclosure, the plurality of PTC rods 300 may be configured to have a structure in which the upper-end PTC rod is separated.

More specifically, the first rod 310 may be configured to have a structure that is separated, and each of the second rod 320 and third rod 330 may be configured to have a structure that is not separated. More specifically, the first rod 310 may be configured to have a third sub-rod and a fourth sub-rod.

Furthermore, the third sub-rod may be connected to the second rod 320 in series, in a structure that is electrically energized, and the structure connected as such may refer to a third PTC module. Furthermore, as mentioned in FIG. 2, the third PTC module may refer to a structure in which the third sub-rod and the second rod 320 are electrically connected in series.

Likewise, the fourth sub-rod may be connected to the third rod 330 in series, in a structure that is electrically energized, and the structure connected as such may refer to a fourth PTC module.

In addition, a third terminal complex may refer to a complex where the terminal 303 of the third sub-rod and the terminal 303 of the second rod 320 are connected. In addition, a fourth terminal complex may refer to a complex where the terminal 303 of the fourth sub-rod and the terminal 303 of the third rod 320 are connected.

In addition, the third terminal complex and one of the terminals 303 of the fourth PTC module, the one adjacent to the third terminal complex, may be inserted into the ground terminal 220.

In addition, when the third PTC module and the fourth PTC module are fastened to the ground terminal 220, the third PTC module may be located between the electrical terminals 221 connected to the two negative (−) poles, and the fourth PTC module may be located with one negative (−) electrical terminal 221 positioned between the third and fourth PTC modules. In other words, one negative (−) electrical terminal 221 may be located between the third PTC module and the fourth PTC module.

In this case, the current applied to the fourth PTC module connected to the ground terminal 220 may flow to an external power source through the negative (−) pole located adjacent to the terminal 303 of the fourth PTC module. In addition, the third PTC module is connected in series with the electrical terminal 221 of the negative (−) pole, which is not connected to the fourth PTC, and the current applied to the third PTC module may flow to an external power source through the connected electrical terminal 221.

Moreover, the third PTC module and the fourth PTC module may be connected in a parallel structure. Through this, the third PTC module and the fourth PTC module may be electrically energized to the external power source.

FIG. 5B is a view showing a structure in which a lower-end PTC rod among the plurality of PTC rods 300 is separated.

According to another embodiment of the present disclosure, the plurality of PTC rods 300 may be configured to have a structure in which the lower-end PTC rod is separated. More specifically, each of the first rod 310 and the second rod 320 may be configured to have a structure that is not separated, and the third rod 330 may be configured to have a structure that is separated. More specifically, the third rod 330 may be configured to have a fifth sub-rod and a sixth sub-rod. As described in FIG. 5A, the separate sub-rod may be connected in series with the rod that is not separated to be electrically energized. More specifically, the fifth sub-rod may be connected in series with the second rod 320 to be electrically energized, and the sixth sub-rod may be connected in series with the first rod 310 to be electrically energized.

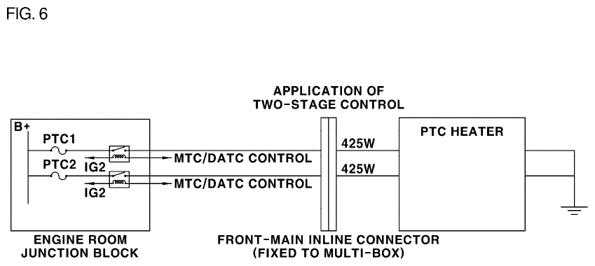

FIG. 6 is a view showing a circuit diagram of a two-stage control according to an embodiment of the present disclosure.

According to an embodiment of the present disclosure, the first PTC module 360 and the second PTC module 370 may be connected in parallel as mentioned in FIG. 4. The first PTC module 360 and the second PTC module 370 connected in parallel may be controlled independently.

One embodiment of the present disclosure includes a PTC heater device capable of two-stage control and requires two relays and two fuses for two-stage control. More specifically, in controlling the PTC heater device of the present disclosure, the parallel circuit may be composed of a relay and a fuse that operate the first PTC module 360 and requires a relay and a fuse that operate the second PTC module 370. Furthermore, in the two-stage control, a first-stage control, where one of the first PTC module 360 and the second PTC module 370 is operated, and a second-stage control, where both modules are operated are possible. In addition, each of the first PTC module 360 and the second PTC module 370 may include more PTC stones 304 than the number of PTC stones 304 included in one PTC rod. Accordingly, each of the first PTC module 360 and the second PTC module 370 may generate more heat output than one PTC rod. More specifically, the PTC heater device may generate an output of 425 W when the first stage is operated and an output of 850 W when the second stage is operated.

In this way, in response to the usage environment or user request, at least one of the first PTC module 360 and the second PTC module 370 may be operated independently, or the first PTC module 360 and the second PTC module 370 may be operated simultaneously in order to provide the maximum output of the PTC heater device.

However, the first PTC module 360 and the second PTC module 370 may be set to have outputs that are different from each other or may be configured to include the same module, and a combination of the modules may be used depending on the design purpose.

According to an example, the PTC heater device is located behind the evaporator in a vehicle's air conditioning system housing and is controlled to operate at least some of the plurality of PTC modules when the temperature is below a user-set level. In addition, when the vehicle controller's discharge temperature, which is measured from the discharge temperature sensor located in the air conditioner duct, is lower than the set temperature, the vehicle controller may be configured to control a relay or circuit such that the PTC heater device is electrically energized from a power supply portion. More specifically, when the discharge temperature and the set temperature have a predetermined temperature difference, the controller may send a signal to the relay to selectively operate either one or both of the first PTC module 360 and the second PTC module 370. More specifically, the controller may send a signal to the first relay to control the first PTC module 360 and a signal to the second relay to control the second PTC module 370.

Furthermore, when a signal is applied to the relay from the controller, the relay that received the signal may provide or close a circuit so that current may electrically energize the PTC module. More specifically, when a signal is applied to the first relay, the first relay turns the switch to the on state in order for current to flow to the first PTC module 360.

Furthermore, when such a circuit is provided, the current flows to the first PTC module 360, heat is generated in the PTC module. The generated heat may be transferred to the heat exchanger portion 210. Moreover, heat exchange with air occurs in the heat exchanger portion 210, and at this time, the discharge temperature of the air may increase.

The detailed description above is illustrative of the present disclosure. In addition, the content described above is provided to explain the present disclosure by showing various embodiments, and that the present inventive concept may be used in various combinations, variations, and environments. In other words, the specification of the present disclosure may be changed or modified within the scope of the disclosed inventive concept, a scope of equivalents to the disclosed content, and/or a scope of technology or knowledge in the art. Accordingly, the detailed description of the present disclosure above is not intended to limit the present disclosure to the disclosed embodiments. In addition, the accompanying claims should be construed to include other embodiments as well.

What is claimed is:

1. A PTC heater device comprising:
a housing unit;
a PTC unit fastened to the housing unit and including a plurality of PTC rods and a heat exchanger portion; and
a ground terminal to which some parts of the plurality of PTC rods are fastened,
wherein at least one of the plurality of PTC rods has a structure that is separated.

2. The PTC heater device of claim 1, wherein the plurality of PTC rods includes a first rod, a second rod, and a third rod, and wherein any one of the first rod, the second rod, and the third rod has the structure that is separated.

3. The PTC heater device of claim 2, wherein the PTC rod of the plurality of PTC rods having the structure that is separated includes a first sub-rod and a second sub-rod.

4. The PTC heater device of claim 3, further comprising:
a first PTC module in which the first sub-rod and one of the plurality of PTC rods that are not separated are connected in series.

5. The PTC heater device of claim 4, further comprising:
a second PTC module in which the second sub-rod and a PTC rod of the plurality of PTC rods that is not connected to the first sub-rod are connected in series.

6. The PTC heater device of claim 5, wherein the first PTC module and the second PTC module are connected to each other in parallel.

7. The PTC heater device of claim 6, wherein the first module and the second module are configured to have a parallel structure when part of the first PTC module and part of the second PTC module are fastened to the ground terminal and energized by being connected to the same external power source.

8. The PTC heater device of claim 4, wherein:
the first PTC module has a structure in which the first sub-rod is connected to a PTC rod of the plurality of PTC rods, which is not separated, with a first busbar; and
the second PTC module has a structure in which the second sub-rod is connected to the PTC rod of the plurality of PTC rods, which is not connected to the first sub-rod, with a second busbar.

9. The PTC heater device of claim 5, wherein:
the first PTC module has a structure in which the first sub-rod is connected to the PTC rod of the plurality of PTC rods, which is not separated, with a first busbar; and
the second PTC module has a structure in which the second sub-rod is connected to the PTC rod of the plurality of PTC rods, which is not connected to the first sub-rod, with a second busbar.

10. The PTC heater device of claim 1, wherein the housing unit comprises:
a lower housing; and
an upper housing fastened to the ground terminal.

11. The PTC heater device of claim 1, wherein each of the plurality of PTC rods comprises:
a guide having a plurality of grooves;
an electrode plate configured to be fastened to the guide;
a terminal connected to one end of the electrode plate;
a PTC stone fastened to each of upper grooves of the guide; and
an insulating portion fastened to each of lower grooves of the guide.

12. The PTC heater device of claim 11, wherein one of the plurality of PTC rods not having a structure that is separated has the electrode plate having opposite ends each connected to the terminal.

13. The PTC heater device of claim 1, wherein the ground terminal comprises:
two electrical terminals; and
a plurality of terminal grooves into which some parts of the plurality of PTC rods are inserted.

14. The PTC heater device of claim 13, wherein, the plurality of terminal grooves includes two adjacent terminal grooves located between the two electrical terminals, each of the two adjacent terminal grooves having one open end.

15. A PTC unit comprising:
a plurality of PTC rods;
a heat exchanger portion configured to be fastened to the plurality of PTC rods; and
a ground terminal to which some parts of the plurality of PTC rods are fastened,
wherein a terminal is connected to each of opposite ends of any one of the plurality of PTC rods, and a PTC rod of the plurality of PTC rods that does not have the terminal connected to each of the opposite ends thereof has the terminal connected to one end thereof.

16. The PTC unit of claim 15, wherein any one of the plurality of PTC rods has a structure that is separated.

17. The PTC unit of claim 16, wherein a PCT rod of the plurality of PTC rods that does not have a structure that is separated has an electrode plate having opposite ends each connected to the terminal.

18. The PTC unit of claim 17, wherein the PTC rod having opposite ends each having the terminal connected thereto includes a first sub-terminal and a second sub-terminal.

19. The PTC unit of claim 18, wherein one of the first sub-terminal and the second sub-terminal is connected to the terminal of the PTC rod having the structure that is separated.

20. The PTC unit of claim 19, wherein another of the first sub-terminal and the second sub-terminal that is not connected to the terminal of the PTC rod having the structure that is separated is fastened to the ground terminal.
